(19) United States
(12) Patent Application Publication
(10) Pub. No.: US 2014/0106972 A1
(43) Pub. Date: Apr. 17, 2014

(54) ALKYLBENZENE SULFONATE SURFACTANTS FOR CONTROLLING HERBICIDE SPRAY DRIFT

(71) Applicant: Dow AgroSciences LLC, Indianapolis, IN (US)

(72) Inventors: Hui Shao, Carmel, IN (US); Hong Zhang, Carmel, IN (US); Holger Tank, Zionsville, IN (US); Mei Li, Westfield, IN (US); Kuide Qin, Westfield, IN (US); Lei Liu, Carmel, IN (US); Stephen L. Wilson, Zionsville, IN (US)

(73) Assignee: Dow AgroSciences LLC, Indianapolis, IN (US)

(21) Appl. No.: 14/050,939

(22) Filed: Oct. 10, 2013

Related U.S. Application Data
(60) Provisional application No. 61/713,053, filed on Oct. 12, 2012.

(51) Int. Cl. A01N 25/30

(52) U.S. Cl. CPC A01N 25/30
USPC 504/206; 504/323; 504/254; 504/362

(57) ABSTRACT

Spray drift during the application of an aqueous mixture of a herbicide, such as an auxinic herbicide, is reduced by incorporating into a spray mixture one or more alkylbenzene sulfonate surfactants.

### CROSS REFERENCE TO RELATED APPLICATIONS

This application claims the benefit of U.S. Provisional Patent Application Ser. No. 61/713,053 filed Oct. 12, 2012, the disclosure of which is expressly incorporated herein by reference.

### BACKGROUND

Agricultural spraying by economical and available technologies uses hydraulic spray nozzles that inherently produce a wide spectrum of spray droplet sizes. The potential for these spray droplets to drift from the initial, desired site of application is found to be a function of droplet size, with smaller droplets having a higher propensity for off-target movement. Significant research efforts, involving numerous field trials, wind tunnel tests, and subsequent generation of predictive math models have led to a greatly enhanced understanding of the relationship between spray droplet size and potential for off-target drift.

Although other factors such as meteorological conditions and spray boom height contribute to the potential for drift, spray droplet size distribution has been found to be a predominant factor. Teske et al. (Teske M. E., Hewitt A. J., Valcore, D. L. 2004. The Role of Small Droplets in Classifying Drop Size Distributions ILASS Americas 17^{th} Annual Conference: Arlington Va.) have reported a value of <156 microns (μm) as the fraction of the spray droplet distribution that contributes to drift. Robert Wolf (Wolf, R. E., Minimizing Spray Drift, Dec. 15, 1997, Microsoft® PowerPoint Presentation, available at www.bae.ksu.edu/faculty/wolf/drift.htm, last viewed Jan. 26, 2012) cites a value of <200 μm as the driftable fraction. A good estimation of droplet size likely to contribute to drift, therefore, is the fraction below about 150 μm.

The negative consequences of off-target movement can be quite pronounced. Some herbicides have demonstrated very sensitive phytotoxicity to particular plant species at extremely low parts per million (ppm) or even parts per billion (ppb) levels, resulting in restricted applications around sensitive crops, orchards, and residential plantings. For example, the California Department of Pesticide Regulation imposes buffers of ½-2 miles for propanil-containing herbicides applied aerially in the San Joaquin valley.

### SUMMARY

Spray drift during aqueous herbicide application can be reduced by incorporating one or more alkylbenzene sulfonate surfactants into an aqueous herbicidal spray mixture. Methods and compositions to reduce spray drift during the application of an aqueous herbicidal spray mixture are described herein. The methods to reduce spray drift during the application of an aqueous herbicidal spray mixture containing a herbicide include incorporating into the aqueous herbicidal spray mixture from 0.01 to 10 weight percent of one or more alkylbenzene sulfonate surfactants.

Additionally, aqueous concentrate compositions are described that include from about 0.1 to about 95 weight percent of a water soluble salt of at least one herbicide and from about 0.01 to about 20 weight percent of one or more alkylbenzene sulfonate surfactants.

### DETAILED DESCRIPTION

Methods and compositions to reduce spray drift are described herein. The methods and compositions reduce the amount of driftable fines of a herbicide spray in both aerial and ground spray applications. The methods include the use of aqueous herbicidal spray mixtures incorporating one or more alkylbenzene sulfonate surfactants and one or more herbicides. Herbicides useful with the methods and compositions described herein include auxinic herbicides such as, for example, triclopyr, 2,4-D, 2,4-DB, MCPA, MCPB, or mixtures thereof. The methods described herein are most particularly useful for the application of herbicides that are subject to restricted applications around sensitive crops such as spray mixtures containing glyphosate, 2,4-D, triclopyr, or mixtures thereof.

The one or more alkylbenzene sulfonate surfactants useful with the methods and compositions described herein have the following general formula I:

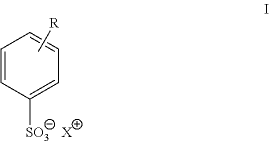

In formula I, the R group can be in the ortho-, meta-, or para-position and is a linear or branched C₈-C₁₈ alkyl group. For example, the R group can be a linear dodecyl (C₁₂) alkyl chain or a branched C₁₂ alkyl chain. The R group can be attached to the benzene ring of the alkylbenzene sulfonate surfactant molecule at any position along the R group. In Formula I, suitable X⁺ cations include isopropyl ammonium, dimethyl ammonium, triethyl ammonium, monoethanol ammonium, diethanol ammonium, triethanol ammonium, dimethylethanol ammonium, diethyleneglycol ammonium, triisopropanol ammonium, tetramethyl ammonium, tetraethyl ammonium, choline, calcium, magnesium, potassium and sodium.

As used herein, an alkylbenzene sulfonate surfactant can include a mixture of linear and/or branched R groups with an array of different lengths (e.g., C₈-C₁₈) attached to the alkylbenzene sulfonate surfactant molecules at different positions along the R group. Similarly, an alkylbenzene sulfonate surfactant can include a mixture of molecules with a uniform length R group (e.g., C₁₂) attached to alkylbenzene sulfonate surfactant molecules at different positions along the R group. Biosoft® N-411 (Stepan Company; Northfield, Ill.) is a commercially available example of a linear alkylbenzene sulfonate as an isopropyl amine salt (indicated to be >90% isopropylamine dodecylbenzenesulfonate). Ninate® 411 (Stepan Company) is a commercially available example of a branched alkylbenzene sulfonate as an isopropyl amine salt (indicated to include a mixture of branched C₉-C₁₇ R groups). Ninate® 60L (Stepan Company) is a commercially available example of a linear alkylbenzene sulfonate as the calcium salt (indicated to include a linear C₁₂ R group).

The one or more alkylbenzene sulfonate surfactants can be incorporated into an aqueous herbicidal spray mixture, for example, by being tank-mixed directly with a diluted herbicidal formulation. The one or more alkylbenzene sulfonate surfactants may be incorporated into the aqueous herbicidal spray mixture at a concentration from 0.01 to 10 weight percent of the final spray mixture. Additional examples of concentrations for the one or more alkylbenzene sulfonate surfactants incorporated into the aqueous herbicidal spray mixture include, from 0.01 to 9 weight percent of the final spray mixture, from 0.01 to 8 weight percent of the final spray mixture, from 0.01 to 7 weight percent of the final spray mixture, from 0.01 to 6 weight percent of the final spray mixture, from 0.01 to 5 weight percent of the final spray mixture, from 0.01 to 4.5 weight percent of the final spray mixture, from 0.01 to 4 weight percent of the final spray mixture, from 0.01 to 3.5 weight percent of the final spray mixture, from 0.01 to 3 weight percent of the final spray mixture, from 0.01 to 2.5 weight percent of the final spray mixture, from 0.01 to 2 weight percent of the final spray mixture, from 0.01 to 1.5 weight percent of the final spray mixture, and from 0.05 to about 1 weight percent (wt %) of the final spray mixture.

The aqueous herbicidal spray mixtures disclosed herein may include insecticides, herbicide safeners, or fungicides, and the aqueous herbicidal spray mixtures may be applied for the control of unwanted plants, fungi, or insects at levels dependent upon the concentration of the active ingredient needed to control the target pest.

The aqueous herbicidal spray mixtures as described herein may be applied in conjunction with one or more other active ingredients to control a wider variety of unwanted plants, fungi, or insects. When used in conjunction with the other active ingredients, the presently claimed compositions can be formulated with the other active ingredient or active ingredients as premix concentrates, tank-mixed with the other active ingredient or active ingredients for spray application, or applied sequentially with the other active ingredient or active ingredients in separate spray applications.

An example of a composition as described herein that may be used in conjunction with another active ingredient comprises an aqueous pre-mix concentrate containing a mixture of glyphosate and an auxinic herbicide such as a water soluble salt of 2,4-D, a water soluble salt of triclopyr, or mixtures thereof. Such aqueous pre-mix herbicidal concentrates may be diluted from 1 to 2000 fold in water at the point of use depending upon the agricultural practices and used in spray applications to control weeds in crops.

In some situations, the aqueous herbicidal spray mixtures may contain one or more biocides. Biocides may be present in the composition from about 0.001 wt % to about 0.1 wt %. For further example, the one or more biocides may be present in the composition at 0.001 wt % to 0.1 wt %, 0.005 wt % to 0.1 wt %, 0.01 wt % to 0.1 wt %, 0.02 wt % to 0.1 wt %, 0.03 wt % to 0.1 wt %, 0.04 wt % to 0.1 wt %, 0.05 wt % to 0.1 wt %, 0.06 wt % to 0.1 wt %, 0.07 wt % to 0.1 wt %, 0.08 wt % to 0.1 wt %, or 0.09 wt % to 0.1 wt %. Examples of biocides include, but are not limited to, bactericides, viricides, fungicides, parasiticides, and the like. Examples of biocide active ingredients include, but are not limited to, phenol compounds (such as phenol, thymol, pentachlorophenol, cresol, and p-chloro-m-xylenol), aldehydic compounds (such as formaldehyde, glutaraldehyde, and paraformaldehyde), acid compounds (such as benzoic acid, sorbic acid, mucochloric acid, and mucobromic acid), esters of p-hydroxybenzoic acid (such as methyl-p-hydroxybenzoate and butyl-p-hydroxybenzoate), rare earth salts, amines, disulfides, heterocyclic compounds (such as thiazinium salts, thiazolinones, and benzimidazoles), quaternary ammonium salts, organic mercury compounds, hexamethylenebiguanide hydrochlorides, benzalkonium chlorides, polyamino propylbiguanides, and 1-2-benzisothiazoline-3-ones. For specific example, an aqueous herbicidal spray mixture may comprise Proxel® GXL (Arch Chemicals Inc., Atlanta, Ga.) as a biocide.

Suitable active ingredients for use in the aqueous herbicidal spray mixtures described herein include herbicides such as, for example, auxinic herbicides (such as 2,4-D, 2,4-DB, fluoroxypyr, MCPA, MCPB, or triclopyr), acetochlor, atrazine, benfluralin, cloransulam, cyhalofop, diclosulam, dithiopyr, ethalfluralin, florasulam, flumetsulam, glufosinate, glyphosate, haloxyfop, isoxaben, MSMA, oryzalin, oxyfluorfen, pendimethalin, penoxsulam, propanil, pyroxsulam, quizalofop, tebuthiuron, and trifluralin. Suitable active ingredients for use in the described compositions also include herbicide safeners such as, for example, cloquintocet, flurazole, mefenpyr, and TI-35. Suitable active ingredients for use in the described compositions also include insecticides such as, for example, chlorpyrifos, chlorpyrifos-methyl, gamma-cyhalothrin, cypermethrin, deltamethrin, halofenozide, methoxyfenozide, sulfoxaflor, spinosad, spinetoram, and tebufenozide. Suitable active ingredients for use in the described compositions also include fungicides such as, for example, fenbuconazole, mancozeb, myclobutanil, propiconazole, quinoxyfen, thifluzamide, and zoxamide.

When the aqueous herbicidal spray mixtures described herein contain water soluble salts of auxinic herbicides and/or the water soluble salt of glyphosate and/or the water soluble salt of glufosinate, suitable cations contained in these salts include ammonium, isopropyl ammonium, dimethyl ammonium, triethyl ammonium, monoethanol ammonium, diethanol ammonium, triethanol ammonium, dimethylethanol ammonium, diethyleneglycol ammonium, triisopropanol ammonium, tetramethyl ammonium, tetraethyl ammonium, choline, and potassium. For example, useful 2,4-D salts include the 2,4-D choline salt and the 2,4-D dimethyl ammonium salt; useful glyphosate salts include the glyphosate dimethyl ammonium salt, the glyphosate isopropyl ammonium salt, and the glyphosate potassium salt; and useful glufosinate salts include glufosinate ammonium.

In an example of an aqueous herbicidal spray mixture, the auxinic herbicide is 2,4-D choline salt or 2,4-D dimethyl ammonium salt and the glyphosate is glyphosate dimethyl ammonium salt, glyphosate isopropyl ammonium salt, or glyphosate potassium salt. In another example of an aqueous herbicidal spray mixture, the auxinic herbicide is 2,4-D choline salt or 2,4-D dimethyl ammonium salt, the glyphosate is glyphosate dimethyl ammonium salt, glyphosate isopropyl ammonium salt, or glyphosate potassium salt, and the one or more alkylbenzene sulfonate surfactants are alkyl amine salts of alkylbenzene sulfonic acids, e.g., branched alkylbenzene sulfonic acids. In a further example of an aqueous herbicidal spray mixture, the auxinic herbicide is 2,4-D choline salt, the glyphosate is glyphosate dimethyl ammonium salt, and the one or more alkylbenzene sulfonate surfactants are isopropyl amine salts of alkylbenzene sulfonate surfactants.

In an example of an aqueous herbicidal spray mixture, the auxinic herbicide is 2,4-D choline salt or 2,4-D dimethyl ammonium salt and the glufosinate is glufosinate ammonium salt. In another example of an aqueous herbicidal spray mixture, the auxinic herbicide is 2,4-D choline salt or 2,4-D dimethyl ammonium salt, the glufosinate is glufosinate ammonium salt, and the one or more alkylbenzene sulfonate surfactants are alkyl amine salts of alkylbenzene sulfonic acids, e.g., branched alkylbenzene sulfonic acids. In a further example of an aqueous herbicidal spray mixture, the auxinic herbicide is 2,4-D choline salt, the glufosinate is glufosinate ammonium salt, and the one or more alkylbenzene sulfonate surfactants are isopropyl amine salts of alkylbenzene sulfonate surfactants.

The optimum spray droplet size depends on the application for which the herbicidal composition is used. If droplets are too large, there will be less coverage by the spray; i.e, large droplets will land in certain areas while areas in between will receive little or no spray coverage. The maximum acceptable droplet size may depend on the amount of composition being applied per unit area and the need for uniformity in spray coverage. Smaller droplets provide more even coverage, but are more prone to drift during spraying. Thus, application parameters such as uniformity in spray coverage must be balanced against the tendency for smaller droplets to drift. For example, if it is particularly windy during spraying, larger droplets may be needed to reduce drift, whereas on a calmer day smaller droplets may be acceptable.

In addition to the physical properties of a particular aqueous herbicidal composition, spray droplet size may also depend upon the spray apparatus, e.g., nozzle size and configuration. The reduction in spray drift may result from a variety of factors including a reduction in the production of fine spray droplets (<150 μm minimum diameter) and an increase in the volume median diameter (VMD) of the spray droplets. In any event, for a given spray apparatus, application, and conditions, and based on the one or more alkylbenzene sulfonate surfactants used, the median diameter of the plurality of spray droplets created using the compositions and methods described herein is increased above that of a spray composition that does not include the one or more alkylbenzene sulfonate surfactants as described herein.

In addition to the methods described above, aqueous concentrate compositions are also described. As used herein aqueous concentrate compositions are solutions containing high concentrations of an aqueous herbicidal spray component described above, i.e., one or more water soluble auxinic herbicide salts and one or more alkylbenzene sulfonate surfactants. The aqueous concentrate compositions are intended to be diluted to provide aqueous herbicidal spray mixtures for use, for example, with the methods described herein. The aqueous concentrate compositions include from 0.1 to 95 weight percent of one or more water soluble salts of at least one herbicide and from 0.01 to 20 weight percent of one or more alkylbenzene sulfonate surfactants. The aqueous concentrate compositions can additionally include glyphosate. In aqueous concentrate compositions as described herein that additionally include glyphosate, the aqueous concentrate compositions can contain about 10 to about 45 weight percent of the water soluble glyphosate salt; about 10 to about 45 weight percent of the one or more water soluble auxinic herbicide salts; and 0.1 to 18 weight percent of the one or more alkylbenzene sulfonate surfactants, 0.1 to 16 weight percent of the one or more alkylbenzene sulfonate surfactants, 0.1 to 14 weight percent of the one or more alkylbenzene sulfonate surfactants, 0.1 to 12 weight percent of the one or more alkylbenzene sulfonate surfactants, 0.1 to 10 weight percent of the one or more alkylbenzene sulfonate surfactants, 0.1 to 9 weight percent of the one or more alkylbenzene sulfonate surfactants, 0.1 to 8 weight percent of the one or more alkylbenzene sulfonate surfactants, 0.1 to 7 weight percent of the one or more alkylbenzene sulfonate surfactants, 0.1 to 6 weight percent of the one or more alkylbenzene sulfonate surfactants, 0.1 to 5 weight percent of the one or more alkylbenzene sulfonate surfactants, 0.1 to 4.5 weight percent of the one or more alkylbenzene sulfonate surfactants, 0.1 to 4 weight percent of the one or more alkylbenzene sulfonate surfactants, 0.1 to 3.5 weight percent of the one or more alkylbenzene sulfonate surfactants, 0.1 to 3 weight percent of the one or more alkylbenzene sulfonate surfactants, 0.1 to 2.5 weight percent of the one or more alkylbenzene sulfonate surfactants, 0.1 to 2 weight percent of the one or more alkylbenzene sulfonate surfactants, 0.1 to 1.5 weight percent of the one or more alkylbenzene sulfonate surfactants, or 0.1 to 1 weight percent of the one or more alkylbenzene sulfonate surfactants. The aqueous concentrate compositions can be stored in suitable containers as will be readily recognized by one of skill in the art and can be, for example, solutions, emulsions, or suspensions.

In an example of an aqueous concentrate composition, the auxinic herbicide is 2,4-D choline salt or 2,4-D dimethyl ammonium salt and the glyphosate is glyphosate dimethyl ammonium salt, or glyphosate isopropyl ammonium salt. In another example of an aqueous concentrate composition, the auxinic herbicide is 2,4-D choline salt or 2,4-D dimethyl ammonium salt, the glyphosate is glyphosate dimethyl ammonium salt, or glyphosate isopropyl ammonium salt, and the one or more alkylbenzene sulfonate surfactants are isopropyl amine salts of alkylbenzene sulfonic acids, e.g., branched alkylbenzene sulfonic acids. In a further example of an aqueous concentrate composition, the auxinic herbicide is 2,4-D choline salt, the glyphosate is glyphosate dimethyl ammonium salt, and the one or more alkylbenzene sulfonate surfactants are isopropyl amine salts of alkylbenzene sulfonic acids, e.g., branched alkylbenzene sulfonic acids.

Aqueous solutions, i.e., including both concentrates and spray solutions, containing 2,4-D and glyphosate are prone to incompatibility under certain conditions and concentrations leading to product performance issues and difficulty in using the products, i.e., difficulty with field applications of the products. Incompatibility in concentrate compositions is minimized by the use of very small amounts of 2,4-D, such as less than about 3 wt % ae (acid equivalent) relative to the total composition. High-strength aqueous compositions of certain organo ammonium salts of 2,4-D and glyphosate where the weight ratio (ae basis) of the 2,4-D salt to the glyphosate salt is from about 2.3:1 to about 1:2.3 and the compositions may contain up to or greater than 350 grams of acid equivalent per litre (g ae/L) of total active ingredients are described in U.S. Patent Application Publication 20100273654A1 which is incorporated herein by reference. These compositions are generally, though not necessarily, homogeneous and free-flowing at temperatures ranging from 54° C. to about −10° C.

Optionally, the compositions described herein may additionally contain surfactants. For example, compositions as described that include glyphosate can optionally include an efficacy enhancing surfactant. The surfactants may be anionic, cationic, or nonionic in character. Examples of typical surfactants include alcohol-alkylene oxide addition products, such as tridecyl alcohol-C₁₆ ethoxylate; sorbitol esters, such as sorbitol oleate; quaternary amines, such as lauryl trimethylammonium chloride; ethoxylated amines, such as tallowamine ethoxylated; betaine surfactants, such as cocoamidopropyl betaine; fatty acid amidopropyl dimethylamine surfactants such as cocoamidopropyl dimethylamine; alkylpolyglycoside surfactants; polyethylene glycol esters of fatty acids, such as polyethylene glycol stearate; block copolymers of ethylene oxide and propylene oxide; salts of mono and dialkyl phosphate esters; and mixtures thereof. The additional surfactant or mixture of surfactants is usually present at a concentration of from about 0.5 to about 20 weight percent of the formulation.

Additionally, compositions optionally containing one or more additional compatible ingredients are provided herein. These additional ingredients may include, for example, one or more pesticides or other ingredients, which may be dissolved or dispersed in the composition and may be selected from acaricides, bactericides, fungicides, insecticides, herbicides, herbicide safeners, insect attractants, insect repellents, plant activators, plant growth regulators, and synergists. Also, any other additional ingredients providing functional utility such as, for example, dyes, stabilizers, fragrants, viscosity-lowering additives, compatibility agents, and freeze-point depressants may be included in these compositions.

Aqueous concentrate compositions are also described that can be used as herbicide tank-mix additives to reduce spray drift during herbicide spray applications. These aqueous concentrate compositions can include from 0.01 to 90 weight percent of one or more alkylbenzene sulfonate surfactants as described above. Such aqueous concentrate compositions are combined at tank mixing with herbicides as described above to reduce spray drift during application of the tank mix.

The following Examples are presented to illustrate various aspects of the compositions and methods described herein and should not be construed as limitations to the claims.

### Example 1

### 2,4-D Choline Aqueous Concentrates with Built-in Alkylbenzene Sulfonate Surfactants

Aqueous herbicide concentrates containing 383 grams acid equivalent per kilogram (g ae/kg) of 2,4-D choline, 50 g/kg propylene glycol, 2.1 g/kg ethylenediaminetetraacetic acid choline salt (EDTA-choline; prepared by adding 1028.25 g of EDTA acid and 689.7 g of deionized (DI) water into 2310.0 g of choline hydroxide solution (45 wt %) and stiffing until all solids are dissolved), and 40 g/kg of an alkylbenzene sulfonate surfactant selected from the following:
1. Ninate® 411, isopropyl amine salt of branched dodecylbenzene sulfonic acid (88%)
2. Bio-soft® N-411, isopropyl amine salt of linear alkylbenzene sulfonate (90%) [Ninate® 411 and Biosoft® N-411 are available from Stepan Company (Northfield, Ill.).]

A 4-ounce (oz) vial was first charged with 86.00 g of a 44.5 wt % ae 2,4-D choline salt solution in water (prepared by dissolving 4171.0 g of 2,4-D acid flake (technical grade, 97.1 wt %) into 4789.4 g of choline hydroxide solution (45% aqueous solution) under low shear agitation to give a solution with a pH of 7.0 and a density of 1.21 grams per milliliter (g/mL)). To the vial were added 5.00 g of propylene glycol and 0.84 g of EDTA-choline solution (25 wt % in water), and the liquids were then blended by hand shaking the flask until a homogenous solution was obtained. Then, 4.00 g of an alkylbenzene sulfonate surfactant were added to the vial. The vial was once again hand shaken until the contents were homogenous. Lastly, DI water was added to provide 100 g (total sample weight) of an herbicide concentrate containing an alkylbenzene sulfonate surfactant. Two concentrate samples each containing one of the alkylbenzene sulfonate surfactants listed above and one concentrate sample containing no alkylbenzene sulfonate surfactant (control sample) were prepared in this manner.

### 2,4-D Choline Herbicide Spray Solutions and Spray Droplet Analysis:

The two aqueous 2,4-D choline concentrates containing the alkylbenzene sulfonate surfactants and the one aqueous concentrate containing only 2,4-D choline and EDTA-choline (control sample) were each tank-mixed with Roundup PowerMax® herbicide containing 2 wt % ammonium sulfate (AMS). Spray solutions were prepared by combining 5.61 mL of each of the three 2,4-D choline concentrates and 4.99 mL of Roundup PowerMax® herbicide (540 g ae/L of glyphosate potassium; available from Monsanto, St. Louis, Mo.) with 289.40 mL of a 2% ammonium sulfate solution in water and then lightly shaking by hand until each spray sample was homogenous. The three samples were sprayed using a Teejet® 8002 flat fan nozzle (Teejet Technologies; Wheaton, Ill.) at 40 pounds per square inch (psi; 276 kiloPascal) and the spray droplet size distribution was measured with a Sympatec Helos/KF high resolution laser diffraction particle sizer with an R7 lens (Sympatec GmbH; Clausthal-Zellerfeld, Germany). The tip of the nozzle was situated 12 inches (30.5 centimeters) above the path of the laser beam of the Sympatec particle sizer. The percentage of driftable fines was expressed as the volume percentage of spray droplets below 150 μm volume mean diameter (VMD) as shown in Table 1.

TABLE 1
Spray Droplet Analysis of 2,4-D Herbicide Sprays Containing
Alkylbenzene Sulfonate Surfactants, Roundup PowerMax ® Herbicide
and AMS

| | Spray | Volume Percent |
|---|---|---|
| Alkylbenzene Sulfonate | Droplet | Driftable |
| Surfactant¹ | VMD, μm | Fines <150 μm VMD |
| none (control) | 154 | 48% |
| Ninate ® 411 | 223 | 25% |
| Bio-soft ® N-411 | 213 | 29% |

¹Ninate ® 411 and Bio-soft ® N-411 are available from Stepan Company (Northfield, IL)

### Example 2

### 2,4-D Choline Aqueous Concentrates with Built-in Alkylbenzene Sulfonate Surfactants and Additional Surfactants

Aqueous herbicide concentrates containing 383 g ae/kg 2,4-D choline, 50 g/kg propylene glycol, 2.1 g/kg ethylenediaminetetraacetic acid choline salt (EDTA-choline), 40 g/kg Ninate® 411, and 10 g/kg each of the following surfactants were prepared as described below:
1. Rhodamox® LO, N,N-dimethyldodecan-1-amine oxide
2. Duomeen® T, tallowalkyldiamine
3. Duoquad® T-50E, N,N,N′,N′,N′-pentamethyl-N-tallow-1,3-propane-diammonium dichloride
4. Ethomeen® O/12, oleyl amine tertiary amine ethoxylate
5. Armeen® M2C, dicocomethylamine
   [Rhodamox® LO is available from Rhodia-Novecare (Cranbury, N.J.); Duomeen®, Duoquad®, Ethomeen® and Armeen® products are available from AkzoNobel (Chicago, Ill.).]

A 4-oz vial was first charged with 86.00 g of a 44.5 wt % ae basis 2,4-D choline salt solution in water. To the vial were added 5.00 g of propylene glycol and 0.84 g of an EDTA-choline aqueous solution (25 wt %), and the liquids were then blended by hand shaking the vial until a homogeneous solution was obtained. To the vial were then added 4.00 g of Ninate® 411, 1.00 g of a surfactant from the list above and enough deionized water to make 100 g of a homogenous herbicide concentrate after blending. Five aqueous concentrates containing Ninate® 411 and one of the surfactants shown above, and one aqueous concentrate containing only 2,4-D choline and EDTA-choline (control sample) were prepared in this manner.

### 2,4-D Choline Herbicide Spray Solutions and Spray Droplet Analysis

The five aqueous 2,4-D choline concentrates containing Ninate® 411 and a surfactant from the list above, and the one aqueous concentrate containing only 2,4-D choline and EDTA-choline (control sample) were each tank-mixed with an aqueous solution of Roundup PowerMax® herbicide diluted in either deionized water or 2 wt % AMS. Spray solutions were prepared by combining 5.61 mL of each of the six 2,4-D choline concentrates and 4.99 mL of Roundup PowerMax® herbicide (540 g ae/L of glyphosate potassium; available from Monsanto, St. Louis, Mo.) with 289.40 mL of either deionized water (Spray Solutions A) or a 2% AMS solution in water (Spray Solutions B). Each of the 12 samples was lightly shaken by hand until homogenous and then was sprayed using the same procedure and equipment described in Example 1. The percentage of driftable fines was expressed as the volume percentage of spray droplets below 150 μm volume mean diameter (VMD) as shown in Table 2.

TABLE 2
Spray Droplet Analysis of 2,4-D Herbicide
Sprays Containing Ninate ® 411
Surfactant and an Additional Surfactant

| | Herbicide Spray Droplet Analysis | |
|---|---|---|
| | | Volume Percentage |
| Surfactant Used¹ (1 | Spray Droplet | of Driftable |
| wt % in concentrate) | VMD, μm | Fines <150 μm VMD |

Spray Solutions A: 2,4-D choline + Roundup PowerMax ® +
listed surfactant

| | | |
|---|---|---|
| none (control 1)² | 150 | 49% |
| Ninate ® 411(control 2)³ | 155 | 48% |
| Rhodamox ® LO | 215 | 29% |
| Duomeen ® T | 242 | 22% |
| Duoquad ® T-50E | 235 | 22% |
| Etomeen ® O/12 | 240 | 22% |
| Armeen ® M2C | 205 | 31% |

Spray Solutions B: 2,4-D choline + Roundup PowerMax ® +
AMS + listed surfactant

| | | |
|---|---|---|
| none (control 1)² | 154 | 48% |
| Ninate ® 411(control 2)³ | 223 | 25% |
| Rhodamox ® LO | 226 | 25% |
| Duomeen ® T | 234 | 23% |
| Duoquad ® T-50E | 238 | 23% |
| Etomeen ® O/12 | 238 | 22% |
| Armeen ® M2C | 252 | 18% |

¹Rhodamox ® LO is available from Rhodia-Novecare (Cranbury, NJ); Duomeen ®, Duoquad ®, Ethomeen ® and Armeen ® products are available from AkzoNobel (Chicago, IL);
²Control sample 1 does not contain Ninate ® 411;
³Control sample 2 contains Ninate ® 411 and no other surfactants.

### Example 3

### Glyphosate Aqueous Concentrates with Built-in Alkylbenzene Sulfonate Surfactants

Aqueous herbicide concentrates containing 406 g ae/kg of glyphosate potassium, 2.5 g/kg ethylenediaminetetraacetic acid choline salt (EDTA-choline) and 40 g/kg alkylbenzene sulfonate surfactant were prepared. A 4-oz vial was first charged with 90.00 g of commercial RoundUp PowerMax® herbicide solution (containing 540 g ae/L of glyphosate potassium; Monsanto; St. Louis, Mo.). To the vial were added 1.00 g of EDTA-choline aqueous solution (25 wt %) and 4.00 g of Ninate® 411 (isopropyl ammonium salt) or Ninate® 60L (calcium salt), and the liquids were then blended by hand shaking the vial until a homogeneous solution was obtained. Deionized water was added to the vial to make 100 g of a homogenous herbicide concentrate after blending. One aqueous RoundUp PowerMax® herbicide concentrate containing Ninate® 411, one aqueous RoundUp PowerMax® herbicide concentrate containing Ninate® 60L and one aqueous RoundUp PowerMax® herbicide concentrate containing no alkylbenzene sulfonate surfactant (control sample) were prepared in this manner.

### Glyphosate Herbicide Spray Solutions and Spray Droplet Analysis:

The aqueous RoundUp PowerMax® herbicide concentrates containing Ninate® 411 or Ninate® 60L and the aqueous concentrate containing only RoundUp PowerMax® herbicide and EDTA-choline (control sample) were each diluted in either deionized water or a 2 wt % AMS solution in water. Spray solutions were prepared by diluting 10 mL of each of the 3 glyphosate concentrates with 490 mL of either deionized water (Spray Solutions A) or a 2% AMS solution in water (Spray Solutions B). Each of the 6 samples was lightly shaken by hand until homogenous and then was sprayed using the same procedure and equipment as described in Example 1. The percentage of driftable fines was expressed as the volume percentage of spray droplets below 150 μm volume mean diameter (VMD) as shown in Table 3.

TABLE 3
Spray Droplet Analysis of RoundUp PowerMax ® Herbicide
Sprays Containing Alkylbenzene Sulfonate Surfactants

Herbicide Spray Droplet Analysis

| | | |
|---|---|---|
| | | Volume Percentage |
| Amount Surfactant in | Spray Droplet | of Driftable |
| Concentrate | VMD, μm | Fines <150 μm VMD |

Spray Solutions A: RoundUp PowerMax ® +
listed surfactant

| | | |
|---|---|---|
| none (control) | 148 | 50% |
| 4 wt % Ninate ® 411 | 274 | 15% |
| 4 wt % Ninate ® 60L | 261 | 17% |

Spray Solutions B: RoundUp PowerMax ® + AMS +
listed surfactant

| | | |
|---|---|---|
| none (control) | 150 | 49% |
| 4 wt % Ninate ® 411 | 269 | 15% |
| 4 wt % Ninate ® 60L | 263 | 16% |

¹Ninate ® 411 and Ninate ® 60L are available from Stepan Company (Northfield, IL)

### Example 4

### 2,4-D DMA Aqueous Concentrates with Built-in Alkylbenzene Sulfonate Surfactants and Duomeen® T Surfactant

Aqueous herbicide concentrates containing 500 g ae/kg 2,4-D dimethylamine (DMA), 2.5 g/kg ethylenediaminetetraacetic acid choline salt (EDTA-choline), 40 g/kg Ninate® 411, and 10 g/kg of Duomeen® T (tallowalkyldiamine) surfactant were prepared. A 4-oz vial was first charged with 90.00 g of a 55.5 wt % ae basis 2,4-D DMA salt solution in water. To the vial was added 1.0 g of an EDTA-choline aqueous solution (25 wt %), and the liquids were then blended by hand shaking the vial until a homogeneous solution was obtained. To the vial were then added 4.00 g of Ninate® 411, 1.00 g of Duomeen® T and enough deionized water to make 100 g of a homogenous herbicide concentrate after blending. One aqueous concentrate containing 2,4-D DMA, EDTA-choline, Ninate® 411 and Duomeen® T, and one aqueous concentrate containing only 2,4-D DMA and EDTA-choline (control sample) were prepared in this manner.

### 2,4-D Dimethylamine Herbicide Spray Solutions and Spray Droplet Analysis:

The aqueous 2,4-D DMA concentrate containing the Ninate® 411 and Duomeen® T and the aqueous concentrate containing only 2,4-D DMA and EDTA-choline (control sample) were each tank-mixed with an aqueous solution of Roundup PowerMax® herbicide diluted in either deionized water or 2 wt % AMS in water. Spray solutions were prepared by combining 5.61 mL of the 2,4-D DMA concentrates and 4.99 mL of Roundup PowerMax® herbicide (540 g ae/L of glyphosate potassium; available from Monsanto, St. Louis, Mo.) with 289.40 mL of either deionized water (Spray Solutions A) or a 2% AMS solution in water (Spray Solutions B). Each of the two samples was lightly shaken by hand until homogenous and then was sprayed using the same procedure and equipment described in Example 1. The percentage of driftable fines was expressed as the volume percentage of spray droplets below 150 μm volume mean diameter (VMD) as shown in Table 4.

TABLE 4
Spray Droplet Analysis of 2,4-D DMA Herbicide
Sprays Containing Ninate ® 411 Surfactant,
Roundup PowerMax ® and an Additional Surfactant

Herbicide Spray Droplet Analysis

| | | |
|---|---|---|
| | | Volume Percentage |
| Amount of Surfactant | Spray Droplet | of Driftable |
| in Concentrate¹ | VMD, μm | Fines <150 μm VMD |

Spray Solutions A: 2,4-D DMA + Roundup PowerMax ® +
listed surfactant

| | | |
|---|---|---|
| none (control)² | 151 | 49% |
| 1 wt % Duomeen ® T | 154 | 48% |

Spray Solutions B: 2,4-D DMA + Roundup PowerMax ® +
AMS + listed surfactant

| | | |
|---|---|---|
| none (control)² | 153 | 48% |
| 1 wt % Duomeen ® T | 238 | 22% |

¹Duomeen ® products are available from AkzoNobel (Chicago, IL);
²Control samples do not contain Duomeen ® T and Ninate ® 411.

### Example 5

### Glufosinate Ammonium Aqueous Concentrates with Built-in Alkylbenzene Sulfonate Surfactants

Aqueous herbicide concentrates containing 274 g ae/kg of glufosinate ammonium, 2.5 g/kg ethylenediaminetetraacetic acid choline salt (EDTA-choline) and 40 g/kg Ninate® 411 (alkylbenzene sulfonate surfactant) were prepared. A 4-oz vial was first charged with 90.00 g of a 30 wt % glufosinate ammonium herbicide solution (prepared by dissolving 90 g of glufosinate ammonium salt in 210 g of water). To the vial were added 1.00 g of EDTA-choline aqueous solution (25 wt %) and 4.00 g of Ninate® 411 (IPA salt), and the liquids were then blended by hand shaking the vial until a homogeneous solution was obtained. Deionized water was added to the vial to make 100 g of a homogenous herbicide concentrate after blending. One aqueous glufosinate ammonium concentrate containing Ninate® 411 and one aqueous glufosinate ammonium concentrate containing no Ninate® 411 (control sample) were prepared in this manner.

### Glufosinate Ammonium Herbicide Spray Solutions and Spray Droplet Analysis:

The aqueous glufosinate ammonium concentrate containing alkylbenzene sulfonate surfactants and the aqueous concentrate containing only glufosinate ammonium and EDTA-choline (control sample) were each diluted in either deionized water or a 2 wt % AMS solution in water. Spray solutions containing glufosinate ammonium were prepared by diluting 10 mL of each of the glufosinate concentrates with 490 mL of either deionized water (Spray Solutions A) or a 2% AMS solution in water (Spray Solutions B). Each of the spray samples was lightly shaken by hand until homogenous and then was sprayed using the same procedure and equipment as described in Example 1. The percentage of driftable fines was expressed as the volume percentage of spray droplets below 150 μm volume mean diameter (VMD) as shown in Table 5.

TABLE 5
Spray Droplet Analysis of Glufosinate Ammonium (AM) Herbicide
Sprays Containing Ninate ® 411 Surfactant

Herbicide Spray Droplet Analysis

| | | |
|---|---|---|
| | | Volume Percentage |
| Amount of Surfactant | Spray Droplet | of Driftable |
| in Concentrate | VMD, μm | Fines <150 μm VMD |

Spray Solutions A: glufosinate AM + listed surfactant

| | | |
|---|---|---|
| none (control) | 158 | 47% |
| 4 wt % Ninate ® 411 | 160 | 45% |

Spray Solutions B: glufosinate AM + AMS +
listed surfactant

| | | |
|---|---|---|
| none (control) | 142 | 53% |
| 4 wt % Ninate ® 411 | 245 | 24% |

### Example 6

### Triclopyr Choline Aqueous Concentrates with Built-in Alkylbenzene Sulfonate Surfactants

Aqueous herbicide concentrates containing 350 g ae/kg triclopyr choline, 2.5 g/kg ethylenediaminetetraacetic acid choline salt (EDTA-choline) and 40 g/kg Ninate® 411 were prepared. A 4-oz vial was first charged with 90.00 g of a 39.0 wt % (ae basis) triclopyr choline salt solution in water. To the vial was added 1.0 g of an EDTA-choline aqueous solution (25 wt %), and the liquids were then blended by hand shaking the vial until a homogeneous solution was obtained. To the vial was then added 4.00 g of Ninate® 411 and enough deionized water to make 100 g of a homogenous herbicide concentrate after blending. One aqueous concentrate containing triclopyr choline, EDTA-choline and Ninate® 411 and one aqueous concentrate containing only triclopyr choline and EDTA-choline (control sample) were prepared in this manner.

### Triclopyr Choline Herbicide Spray Solutions and Spray Droplet Analysis:

The aqueous triclopyr choline concentrate containing Ninate® 411 and the aqueous concentrate containing only triclopyr choline and EDTA-choline (control sample) were each tank-mixed with an aqueous solution of Roundup PowerMax® herbicide diluted in either deionized water or a 2 wt % AMS solution in water. Spray solutions were prepared by combining 6.0 mL of each triclopyr choline concentrate and 4.99 mL of Roundup PowerMax® herbicide (540 g ae/L of glyphosate potassium; available from Monsanto, St. Louis, Mo.) with 289.01 mL of either deionized water (Spray Solutions A) or a 2% AMS solution in water (Spray Solutions B). Each of the spray samples was lightly shaken by hand until homogenous and then was sprayed using the same procedure and equipment described in Example 1. The percentage of driftable fines was expressed as the volume percentage of spray droplets below 150 μm volume mean diameter (VMD) as shown in Table 6.

TABLE 6
Spray Droplet Analysis of Triclopyr Choline Herbicide
Sprays Containing Roundup PowerMax ®
and Ninate ® 411 Surfactant

Herbicide Spray Droplet Analysis

| | | |
|---|---|---|
| | | Volume Percentage |
| Amount of Surfactant | Spray Droplet | of Driftable |
| in Concentrate | VMD, μm | Fines <150 μm VMD |

Spray Solutions A: triclopyr choline + Roundup PowerMax ® +
listed surfactant

| | | |
|---|---|---|
| none (control) | 163 | 45% |
| 4 wt % Ninate ® 411 | 236 | 23% |

Spray Solutions B: triclopyr choline + Roundup PowerMax ® +
AMS + listed surfactant

| | | |
|---|---|---|
| none (control) | 147 | 51% |
| 4 wt % Ninate ® 411 | 235 | 22% |

The present invention is not limited in scope by the embodiments disclosed herein which are intended as illustrations of a few aspects of the invention and any embodiments which are functionally equivalent are within the scope of this invention. Various modifications of the compositions and methods in addition to those shown and described herein will become apparent to those skilled in the art and are intended to fall within the scope of the appended claims. Further, while only certain representative combinations of the composition components and method steps disclosed herein are specifically discussed in the embodiments above, other combinations of the composition components and method steps will become apparent to those skilled in the art and also are intended to fall within the scope of the appended claims. Thus a combination of components or method steps may be explicitly mentioned herein; however, other combinations of components and method steps are included, even though not explicitly stated. The term comprising and variations thereof as used herein is used synonymously with the term including and variations thereof and are open, non-limiting terms.

What is claimed is:

1. A method to reduce spray drift during the application of an aqueous herbicidal spray mixture comprising incorporating into the aqueous herbicidal spray mixture from 0.1 to 10 weight percent of one or more alkylbenzene sulfonate surfactants.

2. The method of claim 1, wherein the one or more alkylbenzene sulfonate surfactants are alkyl amine, calcium, magnesium, potassium or sodium salts of alkylbenzene sulfonic acids.

3. The method of claim 1, wherein the alkyl amine salt is an isopropyl amine salt.

4. The method of claim 1, wherein the herbicide is an auxinic herbicide.

5. The method of claim 1, wherein the herbicide is a water soluble salt of 2,4-D, a water soluble salt of triclopyr, or mixtures thereof.

6. The method of claim 1, wherein the herbicide is a water soluble salt of 2,4-D.

7. The method of claim 1, wherein the herbicide is 2,4-D choline salt.

8. The method of claim 1, wherein the herbicide is 2,4-D dimethyl ammonium salt.

9. The method of claim 1, wherein the herbicidal spray mixture includes an auxinic herbicide and glyphosate or glufosinate.

10. The method of claim 9, further comprising a surfactant selected to reduce spray drift.

11. The method of claim 9, wherein the herbicide is 2,4-D choline salt or 2,4-D dimethyl ammonium salt, and the glyphosate is glyphosate dimethyl ammonium salt, glyphosate isopropyl ammonium salt, or glyphosate potassium salt.

12. The method of claim 9, wherein the herbicide is 2,4-D choline salt or 2,4-D dimethyl ammonium salt, and the glufosinate is glufosinate ammonium salt.

13. The method of claim 9, wherein the herbicide is 2,4-D choline salt or 2,4-D dimethyl ammonium salt, the glyphosate is glyphosate dimethyl ammonium salt, glyphosate isopropyl ammonium salt, or glyphosate potassium salt, and the one or more alkylbenzene sulfonate surfactants are isopropyl amine, calcium, magnesium, potassium or sodium salts of alkylbenzene sulfonic acids.

14. The method of claim 9, wherein the herbicide is 2,4-D choline salt or 2,4-D dimethyl ammonium salt, the glufosinate is glufosinate ammonium salt, and the one or more alkylbenzene sulfonate surfactants are isopropyl amine, calcium, magnesium, potassium or sodium salts of alkylbenzene sulfonic acids.

15. The method of claim 9, wherein the herbicide is 2,4-D choline salt, the glyphosate is glyphosate dimethyl ammonium salt, and the one or more alkylbenzene sulfonate surfactants are isopropyl amine, calcium, magnesium, potassium or sodium salts of alkylbenzene sulfonic acids.

16. An aqueous concentrate composition comprising from 0.1 to 95 weight percent of a water soluble salt of at least one herbicide and from 0.1 to 20 weight percent of one or more alkylbenzene sulfonate surfactants.

17. The aqueous concentrate composition of claim 16, wherein the one or more alkylbenzene sulfonate surfactants are alkyl amine salts of alkylbenzene sulfonic acids.

18. The aqueous concentrate composition of claim 16, wherein the alkyl benzene sulfonate surfactant is an isopropyl amine salt.

19. The aqueous concentrate composition of claim 16, wherein the herbicide is an auxinic herbicide.

20. The aqueous concentrate composition of claim 16, wherein the herbicide is a water soluble salt of 2,4-D, a water soluble salt of triclopyr, or mixtures thereof.

21. The aqueous concentrate composition of claim 16, wherein the herbicide is a water soluble salt of 2,4-D.

22. The aqueous concentrate composition of claim 16, wherein the herbicide is 2,4-D choline salt.

23. The aqueous concentrate composition of claim 16, wherein the herbicide is 2,4-D dimethyl ammonium salt.

24. The aqueous concentrate composition of claim 16, further comprising glyphosate and a surfactant selected to reduce spray drift.

25. The aqueous concentrate composition of claim 24, wherein the herbicide is 2,4-D choline salt or 2,4-D dimethyl ammonium salt and the glyphosate is glyphosate dimethyl ammonium salt or glyphosate isopropyl ammonium salt.

26. The aqueous concentrate composition of claim 24, wherein the herbicide is 2,4-D choline salt or 2,4-D dimethyl ammonium salt, the glyphosate is glyphosate dimethyl ammonium salt or glyphosate isopropyl ammonium salt, and the one or more alkylbenzene sulfonate surfactants are isopropyl amine salts of alkylbenzene sulfonic acids.

27. The aqueous concentrate composition of claim 24, wherein the herbicide is 2,4-D choline salt, the glyphosate is glyphosate dimethyl ammonium salt, and the one or more alkylbenzene sulfonate surfactants are isopropyl amine salts of alkylbenzene sulfonic acids.

28. The aqueous concentrate composition of claim 24, wherein the herbicide is a water soluble salt of 2,4-D and the acid equivalent (AE) weight ratio of the 2,4-D salt to the glyphosate salt is from 2.3:1 to 1:2.3.

29. An aqueous concentrate composition for use as an herbicide tank-mix additive to reduce spray drift during herbicide spray applications comprising from 0.01 to 90 weight percent of one or more alkylbenzene sulfonate surfactants.
